(19) United States
(12) Patent Application Publication
(10) Pub. No.: US 2004/0074398 A1
(43) Pub. Date: Apr. 22, 2004

(54) Steak weight with meat thermometer

(75) Inventors: James J. Griffin, Syracuse, NY (US); Robert W. Coffey JR., Hastings, NY (US)

Correspondence Address: Bernhard P. Molldrem, Jr., 333 East Onondaga Street, Syracuse, NY, 13202, US

(73) Assignee: R. J. Product Solutions, Inc.

(21) Appl. No.: 10/371,092

(22) Filed: Feb. 21, 2003

Related U.S. Application Data
(60) Provisional application No. 60/419,445, filed on Oct. 18, 2002.

(51) Int. Cl. A23L 1/00

(52) U.S. Cl. 99/342

(57) ABSTRACT

A steak or burger weight incorporates a built-in meat thermometer. The steak weight rests on a serving of meat while it cooks. A temperature probe protrudes beneath the steak weight metal plate so that it penetrates into the meat to sense the internal temperature of the meat. A visible indicator located on the steak weight handle indicates when the meat is done to order. The indicator can be a pointer-type gauge, or can include an LCD or one or more LEDs. The cook or chef knows at a glance when the meat is cooked to the customer's order so as to avoid serving the meat when it is over- or under-cooked.

### BACKGROUND OF THE INVENTION

This invention relates to techniques for assisting in the preparation of meat products, and in particular to meat that is cooked by grilling it over a flame on a grille or similar system.

The invention is also concerned with an improved technique for ensuring that the meat is cooked to the customer's order and that it is at the desired internal temperature.

It is common for restaurants to serve orders of meat that are cooked by grilling them, i.e., broiled over a flame in which the portion of meat is laid on a grille. The portion or serving of meat may be a steak, fillet, or similar portion, or may be a patty of ground meat, i.e., a hamburger. In order to facilitate the cooking process, and also to place desirable grille marks on the meat, steak weights are sometimes used. The steak weight is typically a metal plate, i.e., a slab of cast aluminum, that is laid on the steak, patty, or similar portion of meat to press it against the grille.

Generally a restaurant that serves steak or similar meat items will receive several customer orders at about the same time for meat that is to be cooked to various degrees that correspond to the customers' order (that is, rare, medium-rare, medium, medium-well, or well-done), and it is up to the chef or other cook to keep track of the various meat orders and make sure they are cooked to the satisfaction of all the various customers. Cooking steaks is a difficult skill to learn because of the need to constantly check on the doneness of the meat orders, and make adjustments while at the same time doing all the other chores necessary to prepare the other food items for each customer order. It is not infrequent for a steak order to be presented to the customer when it is overcooked or undercooked, which results in additional work for the cook staff to satisfy the customer, and also results in waste of food and in customer dissatisfaction. In addition, many government health departments throughout the country now require that ground beef, i.e., hamburger patties, be cooked to a temperature of at least 160° F., which means that the cook staff has to somehow keep track of the internal temperature of the patty so it is cooked enough, but not cooked too much. There are many meat thermometers available, but these are either in the form of lance-shaped devices that have to be speared into the meat, or hand-held devices, such as combined meat forks and thermometers, that require the cook to pierce the meat at the time he or she wants to test its doneness.

What has been needed, and has been completely unavailable, is a system with which the cook can glance at the various pieces of meat as they are cooking on the grille, and which will let him or her know when the meat is done to customer's order, rather than having to touch each item with a utensil several times, and even then not always obtain a correct result for a chef with less experience.

### OBJECTS AND SUMMARY OF THE INVENTION

Accordingly, it is an object of this invention to provide a simple and straightforward device and technique, combining the use of a weight that rests on the meat as it cooks, with a meat thermometer, so as to avoid the shortcomings of the prior art.

It is another object to provide a technique that permits the chef and cook staff to easily monitor the cooking of a number of steak orders or other grilled meat orders, and to ensure that each of them is cooked exactly to order for each respective customer.

It is a still further object to save time and effort for the chef and cook staff in reducing the time and effort needed in testing the meat orders on the grille.

It is yet another object to ensure that meat orders, particularly ground meat orders such as burgers, are cooked to a sufficient temperature to satisfy health requirements, but without overcooking the meat to render it unpalatable to the customer.

In accordance with an aspect of the present invention, a combined steak weight and meat thermometer has a metal plate of suitable dimensions and weight for holding a serving of meat against a cooking grille. This can be a plate of cast aluminum or another metal. There is a handle rising from an upper surface of the metal plate, and a temperature probe protruding downward through said metal plate. A tip of the temperature probe extends a predetermined distance beneath said metal plate (e.g., about ½ inch) so that it is situated within the portion of meat and registers the internal temperature of the steak, chop, hamburger patty, or other meat item. A visible temperature indicator, which can be a dial, a LCD display, or one or more LEDs, is situated above the metal plate, preferably in the handle, and provides a visible indication of the internal temperature of the meat item that is being grilled. There can be a single temperature probe, or more than one probe, for each steak weight thermometer. The device requires no training for the cook staff to master. It is only necessary to remember to use it when grilling steaks, chops, burgers, or the like.

In a preferred cooking method, the chef puts the steak on the grille, cooks the one side as usual. Then, the chef flips the steak over to cook the other side. The chef here places the steak weight thermometer on the steak, and glances over at the grille from time to time to check on the temperature. When the desired internal temperature (or doneness) is attained, the device so indicates, and the chef can remove the meat from the grille. This technique produces steaks cooked to perfection, taking the guesswork out of the process. There are many fewer steaks returned by the customer, so there is higher customer satisfaction, and less food waste, which is especially important for expensive cuts of meat. Moreover, the meat is cooked at least to a healthy internal temperature.

The meat weight also speeds up cooking time, and helps form desirable grille marks on the steak or other cooked meat item. Placing the meat weight on the steak will automatically push the probe into the steak the desired amount, so the temperature indication accurately reflects the doneness of the interior of the meat. Preferably, the distance that the probe protrudes can be adjusted, so that it will accommodate different cuts of meat, i.e., different thicknesses. This adjustment can be carried out, e.g., by twisting the handle to adjust the probe depth.

The above and many other objects, features, and advantages of this invention will become apparent to persons skilled in the art from the ensuing description of a preferred embodiment, which is to be read in conjunction with the accompanying Drawing.

### BRIEF DESCRIPTION OF THE DRAWING

FIG. 1 is a top plan view of a combination steak weight and meat thermometer according to one embodiment of this invention.

FIG. 2 is an elevational view of thereof.

FIG. 3 is a cross-sectional elevational view of this embodiment.

FIG. 4 is a side elevation of another steak weight and meat thermometer embodying this invention.

FIG. 5 is a perspective view of a third embodiment.

### DETAILED DESCRIPTION OF THE PREFERRED EMBODIMENT

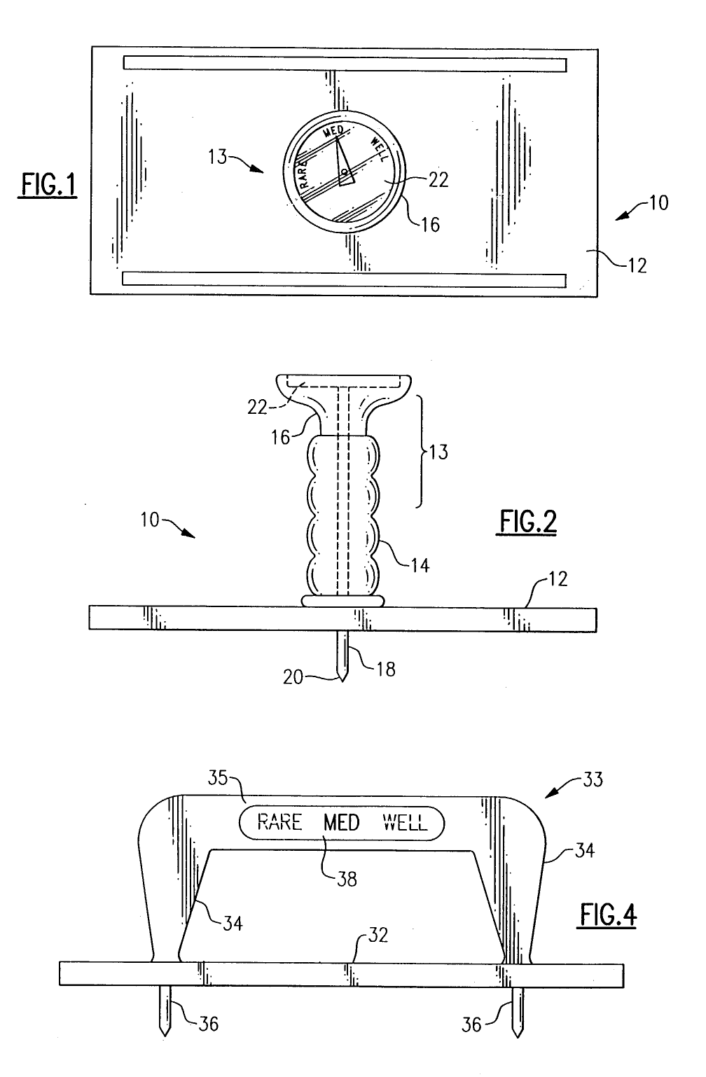

With reference to the Drawing, and initially to FIGS. 1, 2, and 3, a steak weight thermometer 10 comprises a generally flat metal plate or slab 12, from which a handle 13 protrudes upwards to allow the cook or chef to pick the device up and place it on the steak or other meat portion on the grille, and to allow him or her to remove it. The metal plate 12 is the weight element that holds the steak down against the grille to improve cooking, and can be cast aluminum or cast of another metal. The handle 13 has a tubular hollow grip 14 of a heat resistant material of low thermal conductivity, and there are many suitable tough plastic resins that may be used for this purpose. At the top of the handle 13 is a head member 16. A temperature probe 18 comprises an elongated vertical tube that extends down through the handle 13 and then through an opening in the plate 12, with a tip 20 that protrudes a short distance below the lower surface of the metal plate 12. Attached to the upper end of the probe 18 is a gauge 22 that is seated in the head member 16. The gauge 22 provides a visible indication of the temperature sensed at the tip 20 of the probe. In this embodiment, the gauge 22 employs a dial and a rotating hand or needle that can point to suitable temperature indicia that represent the condition on the interior of the cut of meat being grilled or broiled. In other possible embodiments, the visual temperature indicia can be comprised of a liquid crystal display (LCD), or one or more light emitting diodes (LEDs). In this embodiment, the indicia are marked according to familiar terms for the done-ness of the meat serving as ordered from the customer, i.e., “rare”, “med” (medium), and “well” (well-done), but if preferred, a Fahrenheit or Celsius temperature scale can be used instead, or the indicia can be color zones.

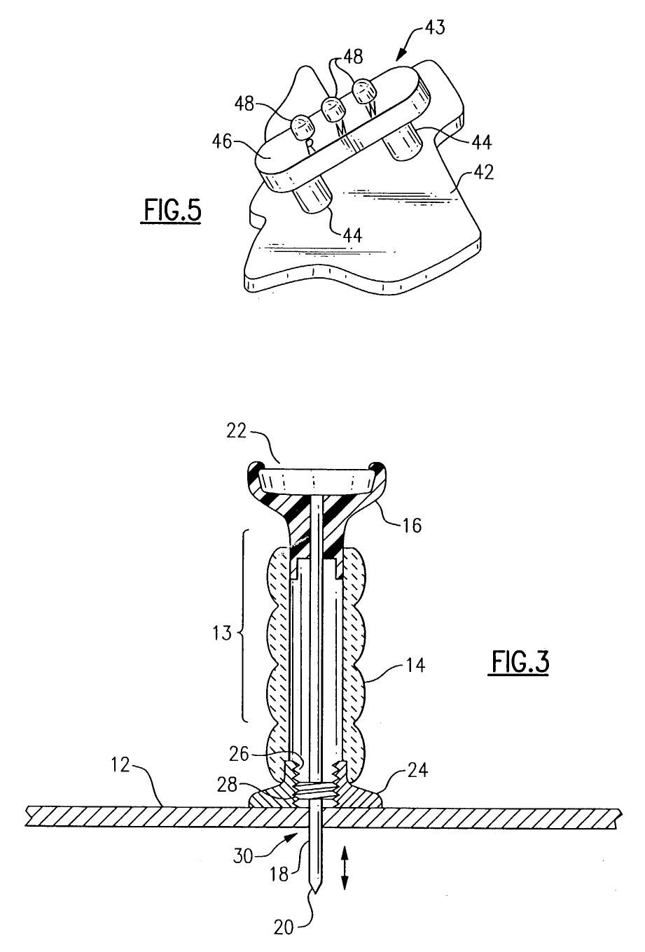

As shown in cross-section in FIG. 3, means may be included in the steak weight thermometer 10 to permit adjustment of the depth that the probe 18 penetrates into the serving of meat. That is, in this embodiment it is possible to adjust the distance that the tip 20 of the temperature probe protrudes below the bottom of the metal plate 12.

As shown in FIG. 3, a metal mount 24 for the handle 13 is formed on or welded to the plate 12, and the tubular grip 14 is secured to this mount 24. There is a female threaded opening 26 in the mount, and a male threaded nut 28 is affixed onto the shaft of the probe 18. The head 16 and the probe 18 can be rotated in respect to the handle grip 14. There is a bore 30 provided in the plate 12 for the probe to pass through. The head 16 is rotated clockwise or counter-clockwise to increase or decrease the penetration distance of the probe 18 below the plate. This is but one example of many equivalent means for changing the distance that the probe protrudes below the metal plate.

One alternative embodiment of the steak weight meat thermometer of this invention is shown in FIG. 4. Here, the device has a flat metal plate 32, with a handle 33 that is generally U-shaped, having a pair of legs 34, 34 and an upper cross bar 35 that serves as a grip. In this embodiment, there are a pair of temperature probes 36, 36, one probe extending from each leg 34 of the handle. One or both of these probes 36 may be active. An LCD temperature indicator is situated in the handle cross bar 35, with indications of “RARE”, “MED”, and “WELL” so that the cook or chef can see at a glance whether the interior of the steak or other meat serving has attained the temperature corresponding to the customer's order. Battery or batteries, as well as the necessary circuitry can reside within the handle 33. Also, this embodiment can be implemented with the handle 33 in the shape of a steer (or other meat animal) if desired. The plate 32 itself can be of an oblong rectangular shape as in the first embodiment, or may be of any other desired shape, such as round or oval.

Another alternative embodiment is illustrated in FIG. 5. Here a cast aluminum metal plate 42 can be made in any arbitrary desired shape, such as in the outline of a particular State or region that may suggest the notion of “beef.” A handle 43 is affixed onto the plate 42 and has a pair of posts 44 that support a cross piece 46 that contains the temperature sensing circuits and batteries. There are one or more temperature probes that protrude below the base of the metal plate 42, but these are not shown in this view. On the top of the handle cross piece 46 are an array of LEDs 48, and these may be configured to light up in turn for the internal steak temperatures representing rare, medium, or well done. For intermediate orders, such as medium-rare and medium-well, then two of the three LEDs 48 may be illuminated together, or a flashing mode may be employed.

There are many other possible implementations beyond the embodiments shown here. For example, a remote indicator or an audio alarm system can be added.

When the customer orders are received, the cook or chef places the various steaks (or other cuts, such as chops, fillets or burgers) on the grille. These are cooked in the usual fashion until the meat has been cooked on one side. Then the various meat orders are flipped so the other side faces down on the grille towards the heat, and steak weight thermometers 10 are placed on each of them. The cook can then check the status of each meat serving as it is being grilled, and take each one off the grille for serving when it is done precisely to the customer's order. This technique avoids any guesswork and avoids having to test the meat with a fork or cut into the steak to check its color visually. The steak weight itself also cuts the cooking time, which means the customer receives his or her food order that much sooner, and the meat comes out with the desired grille marks, which makes the food visually more pleasing to the customer.

The use of the steak weight thermometer is not limited only to beef steak and ground beef patties, but can be used to advantage on pork chops, ham steaks, chicken, turkey, or other cuts of meat, with the temperature indicia being suitably adapted for the type of meat.

While the invention has been described in detail with respect to specific preferred embodiments, it should be recognized that there are many alternative embodiments that would become apparent to persons of skill in the art. Many modifications and variations are possible which would not depart from the scope and spirit of this invention, as defined in the appended claims.

We claim:

1. A steak weight meat thermometer for assisting in grilling of a serving of meat in the form of a steak, chop, fillet, or patty; comprising a metal plate of suitable dimensions and weight for holding said serving of meat against a cooking grille; a handle extending from an upper surface of said metal plate; a temperature probe protruding downward through said metal plate such that a tip thereof extends a predetermined distance beneath said metal plate into said serving of meat; and a visible temperature indicator situated above said metal plate providing a visible indication of an internal temperature of the serving of meat that is being grilled.

2. Steak weight meat thermometer according to claim 1 wherein said metal plate is cast aluminum.

3. Steak weight meat thermometer according to claim 1 wherein said handle includes a generally vertical hollow post disposed centrally on said metal plate.

4. Steak weight meat thermometer according to claim 3 wherein said hollow post is formed of a heat resistant, low thermal conductivity material.

5. Steak weight meat thermometer according to claim 3 wherein said temperature probe has a shaft situated within said hollow post, and said visible temperature indicator is situated at an upper end of said handle.

6. Steak weight meat thermometer according to claim 1 further including means for adjusting the distance that the tip of the temperature probe protrudes beneath said metal plate.

7. Steak weight meat thermometer according to claim 1 wherein a pair of probes protrude beneath said metal plate.

8. Steak weight meat thermometer according to claim 1 wherein said temperature indicator includes an LCD indicator situated in said handle.

9. Steak weight meat thermometer according to claim 1 wherein said temperature indicator includes at least one LED.

10. Steak weight meat thermometer according to claim 1 wherein said temperature indicator includes a plurality of LEDs which light at different internal temperatures of said serving of meat.

11. A method of preparing a serving of grilled meat upon a cooking grille, comprising the steps of placing the serving of meat upon the grille with one side facing down toward the heat; after a period of time, turning the serving of meat on the grille so that the other side is facing down towards the heat; placing on said one side a meat weight thermometer which includes a metal plate that is adapted for seating upon the serving of meat, a handle that extends upward from the metal plate, a temperature probe that protrudes down through said metal plate beneath a lower surface thereof into said serving of meat, and a visible temperature indicator situated above the metal plate and which provides a visible indication of an internal temperature of said serving of meat; and removing the serving of meat from said grille when said visible temperature indicator shows that the meat internal temperature has reached a desired level.
